(19) United States
(12) Patent Application Publication
(10) Pub. No.: US 2023/0399779 A1
(43) Pub. Date: Dec. 14, 2023

(54) Polymeric Non-Woven Mat

(71) Applicant: America Plastics, LLC, Knoxville, TN (US)

(72) Inventors: Patricio Javier De Vincente Mingo, Santiogo (CL); Alejandro Alban, Knoxville, TN (US)

(73) Assignee: America Plastics, LLC, Knoxville, TN (US)

(21) Appl. No.: 18/454,873

(22) Filed: Aug. 24, 2023

Related U.S. Application Data
(63) Continuation-in-part of application No. 16/933,202, filed on Jul. 20, 2020.
(60) Provisional application No. 62/937,861, filed on Nov. 20, 2019.

(51) Int. Cl. D04H 1/4391; C08L 27/06; C08J 9/00; C08J 9/10; D04H 1/4291; D04H 1/56; D04H 3/007; D04H 3/16

(52) U.S. Cl. CPC D04H 1/43916; C08L 27/06; C08J 9/0061; C08J 9/0023; C08J 9/103; D04H 1/4291; D04H 1/56; D04H 3/007; D04H 3/16; C08L 2203/12; C08L 2207/04; C08L 2205/06; C08L 2203/14; C08J 2203/04; C08J 2327/06; C08J 2423/16; D10B 2321/041; D10B 2401/063; D10B 2505/20; D10B 2401/08

(57) ABSTRACT

A non-woven polymeric mat for protecting pipelines, the mat including a plurality of extruded, strands derived from a polymer blend of pelletized polyvinyl chloride (PVC) resin having a k-value ranging from 60 to 70 and an olefin-based thermoplastic elastomer (TPE), wherein the amount of TPE in the polymer blend ranges from about 2.8 parts by weight to about 4 parts by weight per 100 parts by weight of PVC resin in the polymer blend and is sufficient to improve the modulus and tensile strength of the mat, and further wherein the polymer blend is devoid of a nucleating agent and is devoid of a cross-linking agent, and wherein the extruded strands have a specific gravity ranging from about 1.25 to about 1.4.

### RELATED APPLICATION

This application is a continuation-in-part application of application Ser. No. 16/933,202, filed Jul. 20, 2020, now pending, which is a continuation-in-part of provisional application Ser. No. 62/937,861, filed Nov. 20, 2019, now abandoned.

### TECHNICAL FIELD

The invention relates to a polymeric non-woven mat made of thermoplastic material. In particular, the invention relates to an improved polymeric non-woven mat that is made from extruded strands of a polymeric blend and to a method for producing a matted continuum of extruded filaments

### BACKGROUND AND SUMMARY

Polymeric non-woven mats find a variety of uses including but not limited to rock shield pads, roofing, and waterproofing membranes, waterstops and waterbars, pipes and hosepipes, joint sealings and cable coatings, outdoor carpeting and roofing, pipeline protection matts, electrical cable splicing molds, and the like. Rock shield pads are used to absorb shock and made of non-woven mats consisting of small diameter (approximately 1.25 mm) strands of polymeric material suitable for pipeline protection.

While the existing products show satisfactory properties, what is needed is a flexible non-woven polymeric mat that has improved tensile strength and improved modulus properties.

With regard to the foregoing an embodiment of the disclosure provides a non-woven polymeric mat for protecting pipelines. The mat includes a plurality of extruded, strands derived from a polymer blend of a pelletized polyvinyl chloride (PVC) resin having a k-value ranging from 60 to 70 and an olefin-based thermoplastic elastomer (TPE). The amount of TPE in the polymer blend ranges from about 2.8 parts by weight to about 4 parts by weight per 100 parts by weight of PVC resin in the polymer blend and is sufficient to improve the modulus and tensile strength of the mat. Also, the polymer blend is devoid of a nucleating agent and devoid of a cross-linking agent. The extruded strands have a specific gravity ranging from about 1.25 to about 1.4.

In some embodiments, there is provided a method for making a polymeric non-woven mat. The method includes preparing a polymer blend from a pelletized polyvinyl chloride (PVC) resin having a k-value ranging from 60 to 70, a thermoplastic olefin elastomer (TPE) in an amount ranging from about 2.8 to about 4.0 parts by weight per 100 parts by weight of PVC resin in the polymer blend, and a plasticizer, wherein the polymer blend is devoid of a cross-linking agent. Strands derived from the polymer blend are extruded through a die onto a rotating casting cylinder to produce the polymeric non-woven mat derived from extruded polymer blend wherein the strands of the polymeric non-woven mat have a specific gravity ranging from about 1.25 to about 1.4.

In some embodiments, the polymer blend further includes a plasticizer. In some embodiments, the plasticizer is selected from dioctyl phthalate (DOP), dioctyl terephthalate (DOTP), dioctyl adipate (DOA), tri-2-ethylhexyl trimellitate (TOTM), epoxide soybean oil (ESO), and mixtures thereof. In other embodiments, the amount of plasticizer in the polymer blend ranges from about 50 to about 60 parts by weight per 100 parts by weight of the polymer blend.

In some embodiments, the extruded foamed strands are derived from a polymer blend further comprising a blowing agent. In some embodiments, the blowing agent is present in the polymer blend in an amount ranging from about 4.0 to about 5.0 parts by weight per 100 parts by weight of the PVC resin in the polymer blend. In some embodiments, the blowing agent is selected from azodicarbonamide, azobisisobutyronitrile, benzenesulphonyl hydrazide, 4,4-oxybenzenesulphonyl semicarbazide, 4,4-oxybis(benzenesulphonyl hydrazide), diphenyl sulphone-3,3-disulphonyl hydrazide, p-toluenesulphonyl semicarbazide, sodium bicarbonate, ammonium carbonate, ammonium bicarbonate, potassium bicarbonate, diazoaminobenzene, diazoaminotoluene, hydrazodicarbonamide, diazoisobutyronitrile, barium azodicarboxylate and 5-hydroxytetrazole

In some embodiments, the amount of TPE in the polymer blend ranges from 3.0 to about 3.5 parts by weight TPE per 100 parts by weight PVC resin in the polymer blend.

In some embodiments, the die has orifice diameters ranging from about 0.2 mm to about 0.8 mm.

In some embodiments, the method further includes a jet of air from an elongated nozzle into a gap widthwise between the strands and the rotating cylinder substantially parallel to a traveling direction of the non-woven mat to increase or decrease a density of the non-woven mat.

In some embodiments, the extrusion takes place at temperatures ranging from about 148° C. to about 163° C.

An advantage of the disclosed embodiments is that the disclosed embodiments provide a foamed non-woven polymeric mat having superior modulus and tensile strength properties compared to conventional foamed PVC non-woven mats at temperatures below 0° C. and improved elongation, tensile strength, and modulus at temperatures above 10° C.

### BRIEF DESCRIPTION OF THE DRAWINGS

FIG. 1 is a diagrammatic view in elevation of an apparatus for making a continuous filament polymer mat according to an embodiment of the disclosure.

FIG. 2 is a partial plan view, not to scale, of an extruder orifice plate for use in the apparatus of FIG. 1 showing an extrusion aperture distribution pattern.

FIG. 3 is an enlarged sectional view, not to scale, of the orifice plate of FIG. 2.

FIG. 4 is an elevational view, not to scale, of a filament free-fall distance adjusting mechanism for use with the apparatus of FIG. 1.

FIG. 5 is a plan view, not to scale, of a mat formed according to an embodiment of the disclosure.

FIG. 6 is a fragmented cross-sectional view, not to scale, of the mat material of FIG. 5.

FIGS. 7-8 are graphs of 100% modulus versus amount of rubber in PVC formulations made with and without blowing agents.

FIGS. 9-10 are graphs of tensile strength versus amount of rubber in PVC formulations made with and without blowing agents.

FIGS. 11-12 are graphs of elongation versus amount of rubber in PVC formulations made with and without blowing agents.

### DETAILED DESCRIPTION OF THE INVENTION

Throughout the description and the claims, indications of weight percentages (% by weight) are based on the total weight of the polymeric blend unless specified otherwise. As used herein the term “polymer blend” means all of the components used to make the extruded strands for a non-woven web regardless of how and when the components are combined in the extruder. The term “parts per 100 parts of PVC” means the number of parts by weight of a component with respect to 100 parts by weight of polyvinyl chloride resin in the formulation disregarding the amount of other components in the formulation.

The PVC blend comprises a mixture of polyvinyl chloride, natural or synthetic rubber, plasticizers, optional blowing agents, fillers, lubricants, and stabilizers to provide unique properties to a wide range of end products. Any common commercially available polyvinyl chloride resin can be used in the formulation. Pure, non-copolymerized polyvinyl chloride resin is particularly preferred as the PVC resin for the disclosed embodiments. PVC is also designated polyvinyl chloride resin. PVC or PVC resin is generally supplied in powder form and in pellet form. The polymerization degree of the PVC may range from 600 to 2,700 and the k-value of the PVC resin may range from about 60 to about 70. The PVC resin may be provided by a suspended or emulsified PVC resin. For the purposes of the disclosure a suspended PVC resin or predominantly suspended PVC is particularly preferred.

The amount of PVC resin in the PVC blend may vary over a wide range but is preferably from about 20 to about 70% by weight, more preferably from about 30 to about 60% by weight and still more preferably from about 40 to about 50% by weight based on a total weight of the polymer blend.

An important component of the PVC blend is a natural or synthetic rubber component. The natural or synthetic rubber component may be present in an amount ranging from 2 to less than about 5 parts by weight per 100 parts by weight of PVC resin, and more particularly, from about 2.8 parts by weight to about 4 parts by weight per 100 parts by weight of PVC resin in the polymer blend, such as from about 3.0 parts by weight to about 3.5 parts by weight per 100 parts by weight of PVC resin. In some embodiments, the rubber component is a synthetic rubber selected from an olefin-based thermoplastic elastomer (TPE), such as TPE available under the tradename SARLINK 3170 and other synthetic rubber materials such as a crosslinked copolymer of butadiene and acrylonitrile. The crosslinked butadiene and acrylonitrile synthetic rubbers will normally contain (a) from about 45 weight percent to about 79 weight percent butadiene, (b) from about 20 weight percent to about 50 weight percent acrylonitrile and (c) from about 0.5 weight percent to about 5 weight percent of a crosslinking agent. Such crosslinked nitrile rubbers will preferably contain (a) from about 58 weight percent to about 71 weight percent butadiene, (b) from about 28 weight percent to about 38 weight percent acrylonitrile and (c) from about 1 weight percent to about 4 weight percent of the crosslinking agent. The crosslinked nitrile rubber will more preferably contain from about 1.5 weight percent to about 3.5 weight percent of the crosslinking agent. The percentages reported in this paragraph are based upon the total weight of the crosslinked nitrile rubber.

The polymer blend further includes at least one plasticizer. A variety of plasticizers are used to produce flexible PVC. The skilled person is familiar with the compounds suitable as plasticizer in PVC which are also compiled in numerous plastics handbooks. Any conventional plasticizer may be used. It is possible to use one plasticizer or a mixture of two or more plasticizers. Mixtures of plasticizers are often used to obtain desired properties. The amount of plasticizer may range from about 50 to about 60 parts plasticizer per 100 parts of PVC resin in the PVC blend.

When heated, the energies of molecular motions become greater than the intermolecular forces, which widen molecular distances, resulting in softening of the resin. When plasticizers are added to PVC, the plasticizer molecules make their way between the PVC molecules and prevent the PVC polymer molecules from coming closer with each other. Consequently the polymer molecules are kept apart even at normal temperature and softness is maintained.

Examples of plasticizers are phthalic acid diesters (also known as “phthalates”) such as dialkyl phthalates, alkyl benzyl phthalates, and dialkyl terephthalates, epoxides, aliphatic carboxylic diesters, polyester-type polymers, adipic polyesters, phosphate esters, such as triaryl and alkylaryl phosphates, trimellitate esters, benzoate and dibenzoate esters, citrate esters and alkyl sulphonic esters of phenol and mixtures thereof.

Specific examples of plasticizers are dibutyl phthalate (DBP), diisobutyl phthalate (DIBP), di-isononyl phthalate (DINP), diallyl phthalate (DAP), di-2-ethylhexyl-phthalate (DEHP or DOP), diisodecyl phthalate (DIDP), di(2-propyl heptyl) phthalate (DPHP), di-2-ethylhexyl adipate (DOA), di(tridecyl)phthalate (DTDP), butyl benzyl phthalate (BBP), dihexyl phthalate, tri-2-ethyl hexyl trimellitate (TOTM), dioctyl phthalate, condensation products of glycols such as 1,3 butylene glycol with dibasic organic acids such as adipic acid, dipropylene glycol dibenzoate, epoxidized soybean oil, and mixtures thereof.

The amount of plasticizers in the plasticized polymer blend may vary in wide ranges but is preferably from about 15 to about 45% by weight, more preferably from about 20 to about 40% by weight and still more preferably from about 20 to about 31% by weight based on a total weight of the polymer blend. Accordingly, based on 100 parts of PVC resin in the blend, the amount of plasticizer may range from about 50 to about 60 parts plasticizer per 100 parts of PVC resin in the PVC blend.

In the embodiments disclosed herein, the polymer blend is devoid of a nucleating agent. In some embodiments, the polymer blend is devoid of processing aids and pumice.

In some embodiments, the polymer blend further contains from about 0 to about 3% by weight of chemical blowing agent. The amount of the chemical blowing agent in the polymer blend is preferably from about 0.3 to about 2.5% by weight, more preferably from about 0.4 to about 2% by weight based on a total weight of the polymer blend. In terms of 100 parts by weight of PVC resin, the polymer blend may contain from 0 to about 5.0 parts by weight of blowing agent per 100 parts by weight of PVC resin such as from about 2 to about 5 parts by weight of blowing agent per 100 parts by weight PVC resin. A chemical blowing agent generates gas by a chemical reaction, e.g. decomposition, which is induced e.g. by temperature increase.

Examples of suitable chemical blowing agents are azodicarbonamide, azobisisobutyronitrile, benzenesulphonyl hydrazide, 4,4-oxybenzenesulphonyl semicarbazide, 4,4-oxybis(benzenesulphonyl hydrazide), diphenyl sulphone-3,3-disulphonyl hydrazide, p-toluenesulphonyl semicarbazide, sodium bicarbonate, ammonium carbonate, ammonium bicarbonate, potassium bicarbonate, diazoaminobenzene, diazoaminotoluene, hydrazodicarbonamide, diazoisobutyronitrile, barium azodicarboxylate and 5-hydroxytetrazole, wherein sodium bicarbonate is preferred.

The median particle size of the chemical blowing agent, in particular sodium bicarbonate, may range from about 1 to about 50 microns, preferably about 2 to about 30 microns and more preferably about 2 to about 10 microns.

In some embodiments, a high molecular weight acrylic polymer may be included in the polymer blend as a foaming aid. Acrylic polymer is a polymer or copolymer of acrylic monomers such as methyl (meth)acrylate, ethyl (meth)acrylate and butyl (meth)acrylate where (meth)acrylate means acrylate or methacrylate. The high molecular weight acrylic polymer may be selected from high molecular weight PMMA. PMMA is the common abbreviation for polymethyl methacrylate. The high molecular weight acrylic polymer preferably has a weight average molecular weight (Mw) of at least about 500,000, more preferably at least 1,500,000 as determined by gel permeation chromatography (GPC) using polystyrene as a standard.

The polymer blend may be free of high molecular weight acrylic polymer or may contain it. When used, the amount of high molecular weight acrylic polymer in the polymer blend is preferably not more than about 9% by weight, more preferably not more than about 3% by weight, still more preferably not more than about 2% by weight. In some embodiments, the polymer blend contains not more than about 1.2% by weight high molecular weight acrylic polymer based on a total weight of the polymer blend.

Fillers may also be used in the polymer blend. It is usually preferred that at least one filler be incorporated in the polymer blend. Any filler conventional in the field of PVC compounding may be used. It is possible to use one filler or a mixture of two or more fillers. The filler is usually an inorganic particulate solid. Examples of suitable fillers are calcium carbonate, diatomaceous earths, mica, and calcined clays and mixtures thereof, where calcium carbonate is preferred. Any grades of dry-ground, wet-ground, or precipitated calcium carbonate may be used. The calcium carbonate may be e.g. limestone, marble, calcite, or chalk. Chalk is often a preferred filler. The filler may be surface treated, e.g. by hydrophobic treatment.

The amount of filler in the polymer blend may vary in wide ranges but preferably ranges from about 5 to about 45% by weight, more preferably from about 10 to about 30% by weight and still more preferably from about 15 to about 25% by weight, in particular about 22 to about 22% by weight based on a total weight of the polymer blend. In terms of 100 parts by weight of PVC resin in the blend, the amount of filler may range from about 45 to about 55 parts by weight filler per 100 parts by weight PVC resin in the blend.

The polymer blend may include a stabilizer. Stabilizers are usually added into such polymer blends. It is possible to use one stabilizer or a mixture of two or more stabilizers. The use of stabilizers is conventional in the field of PVC compounding. The main purpose of stabilizers in flexible PVC compositions is to prevent degradation during processing and forming into finished shapes. Most stabilizers are metal compounds such as calcium compounds, tin compounds, zinc compounds and mixed metal compounds. A number of lead compounds and cadmium compounds are also suitable but the use thereof is decreasing or stopped due to environmental and health concerns.

Examples of suitable stabilizers are metal salts of carboxylic acids, especially fatty acids such as stearate, palmitates and laureates (“metallic soaps”), e.g. calcium stearate, organotin compounds, and mixed metal carboxylates, such as systems based on barium, zinc and calcium carboxylates, in particular Ba—Zn carboxylates and Ca—Zn carboxylates, for instance a mixture of barium and zinc stearate or a mixture of calcium stearate and zinc stearate. Mixed metal stabilizers are often used together with co-stabilizers.

The amount of stabilizer in the polymer blend may vary in wide ranges but is preferably from about 0.5 to about 5% by weight, more preferably from about 1 to about 3% by weight and still more preferably from about 1.0 to about 2.0% by weight based on a total weight of the polymer blend. In terms of 100 parts by weight of PVC resin in the blend, the amount of stabilizer may range from about 3.5 to about 4.5 parts by weight filler per 100 parts by weight PVC resin in the blend.

The polymer blend may also include further additives which are conventional in the field of PVC compounding. Such further additives are e.g. lubricants, coloring agents, such as pigments, fire retardants, co-stabilizers, anti-microbials, UV-screeners, acid scavengers, and antistatic agents. In some particularly suitable embodiments, the polymer blend is devoid of processing aids and pumice.

The components of the polymer blend may be mixed or fused to obtain a dry blend or pellets. Dry blending is conventionally carried out in a dry blender. Dry blends are common in the field of PVC compounding. In the typical dry blending process, the PVC resin particles intermingle with all the other additives to produce the final homogenously mixed material. Mixture or fusion in dry blends is accomplished by a combination of stress and temperature.

The dry blend or pellets may be used to prepare a foamed extruded polymeric strand containing a blend of PVC and a natural or synthetic rubber. The method comprises the step of extruding the polymeric blend by an extrusion plant with an extruder and a die. The extrusion process as such is well known to the skilled person.

The process consist in a sequence of steps whose purpose is to ensure the complete plasticization of the polymer blend, the effective inclusion of additives without losing or altering their characteristics and utilizing the minimum energy possible, consequently not damaging the integrity of the resulting polymeric filaments.

In summary, the process may be summarized as:
Preparation of mixer (cleaning, inspection);
Resin addition;
Dry additives addition and processing aids inclusion at room temperature;
Agitation into critical point (rpm and temperature) of 43-60° C.;
Plasticizer inclusion under controlled temperature of 40-73° C.;
Liquid additives sequential inclusion under controlled temperature of 40-73° C.;
Agitation into secondary point (rpm and temperature) of 65-85° C.;
Plasticizer inclusion under controlled temperature of 65-85° C.;
Liquid additives (plasticizer and stabilizer) sequential inclusion under controlled temperature of 65-85° C.;
Final additives inclusion including filler under 90-110° C. temperature keeping agitation until mix is homogeneous; and
Drop of mix into cooling device for rapid stabilization;

The extrusion plant may be a conventional device used in the field of polymer extrusion e.g. comprising an extruder with a barrel and a screw unit contained in the barrel or a ram and a die. The extruder may be conventional extruder, e.g. a ram extruder and a screw extruder such as a single screw extruder or a twin screw extruder. A single screw extruder is preferred. The extruder preferably has a high L/D ratio, wherein L is the screw length and D is the screw diameter. The ratio L/D of the extruder may be e.g. at least 25, preferably at least 30 and more preferably at least 35.

The extruder barrel has a feed port where the material to be extruded enters the extruder and an outlet port where the material leaves the barrel. The outlet port is coupled with the die via a gate or adapter piece. A static melt blender may be interposed between the barrel and the die.

Upstream means the direction to the feed port and downstream means the direction to the outlet port. The feed port is generally connected with a hopper to which the material to be extruded is added. It is preferred that a screen pack and breaker plate are positioned at the end of the barrel to avoid plugging in the nozzles.

The extruder barrel comprises at least a plastication and compression zone and a metering zone downstream of the plastication and compression zone. In the plastication and compression zone at the end of the feed port the material is fed, and a major part of the polymer blend is melted and compressed. In the metering zone the melt is homogenized and metered or pumped out the outlet port.

The extruder further generally comprises heating elements, cooling elements, temperature sensors and temperature control elements to provide temperature control zones along the barrel which are designated barrel zones. The extruder may comprise e.g. 3 to 8 barrel zones, preferably at least 5 barrel zones, by which a temperature profile can be realized in the barrel.

In some embodiments, the process includes extruding along an extrusion line at an extrusion velocity a multiplicity of continuous polymer filaments near the rotational top of a casting cylinder which is rotatably driven at a rate coordinated to the filament extrusion velocity about and axis generally parallel to the extrusion line to cause looping of filaments on the cylinder to develop a desired non-woven mat thickness. The accumulated extruded strands are carried by the cylinder surface to about lower dead center where the strands are peeled from the drum surface and gently transferred onto an endless belt at a cylinder-to-belt transfer line for extended support while cooling and curing the non-woven mat. A high volume air jet may be discharged between the mat and the belt generally in the direction of movement of the belt adjacent the cylinder-to-belt-transfer line to provide an air-lift effect for transitional support and product lofting. To reduce the length of the support belt conveyor, additional cooling air flow may be provided along the belt traveling course. Due to the openness of the mat structure it is necessary to protect the filament free-fall from strong drafts originating from the high volume jet. Such draft protection preferably takes the form of baffle plates supported adjacent the extrusion head and extending down to close proximity with the cylinder and mat surface, respectively. The baffle plates minimize undesirable air flow into the area of the filaments falling onto the cylinder so that accumulation of the filaments on the cylinder is not disaffected by the air lift imported by the air jet.

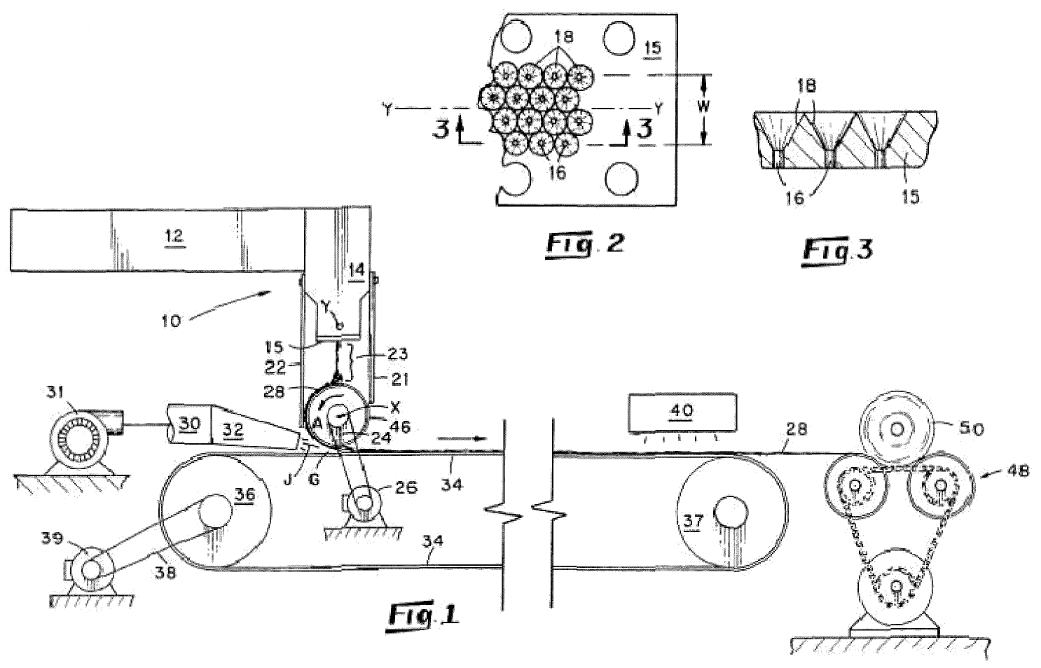

FIGS. 1-3 illustrate features of an extruder system for making foamed extruded strands for a non-woven mat from the polymer blend described herein.

The extrusion apparatus 10 includes a raw material loading system such as a hopper to supply pelletized or powdered polymer to a heating barrel 12 where it is melted to a viscous liquid above 160° C., depending on the particular polymer blend. A powered screw mechanism within the barrel 12 forces the melted plastic through an adapter into an elongate die block 14.

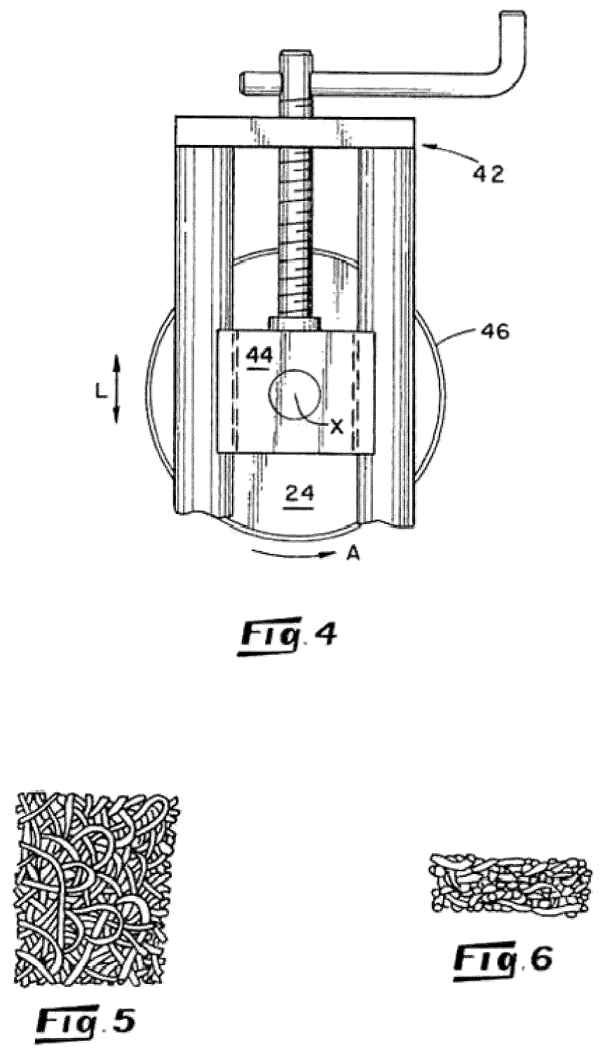

The lower face of the die block 14 includes an orifice plate 15 perforated by a multiplicity of closely spaced orifices 16, best illustrated by FIG. 2, from which respective filaments are extruded into an adjustable free-fall zone 23 preferably of about 25.4 mm to about 254 mm in height. Orifice diameters as small as 0.2 mm and as large as 0.8 mm have been successfully used. As noted from FIG. 3, orifice lead-in fairing cones 18 are provided to reduce flow resistance of the viscous melt into the orifice apertures. The total band width W of the orifice pattern may be about 25.4 mm, each orifice row being separated by about 6.3 mm for a total of 4 rows. As seen in FIG. 2, the rows are preferably staggered at ½ spacing between the orifices of adjacent rows. A casting cylinder 24 having an independent rotational drive means 26 such as a variable speed electric motor is adjustably aligned beneath the extrusion plate 15 to receive the free-falling filaments 23 at about 30 degrees either side of a rotational top dead center. The cylinder is rotatably driven on a suitable support (see, e.g. FIG. 4) for rotation in the direction of arrow A about a rotational axis X which is preferably parallel to and vertically beneath the length axis Y of die block 14, both axes X and Y coming out of the page as viewed in FIG. 1.

By means such as a manual jack-screw mechanism 42, as shown by FIG. 4, for vertically adjusting the position of journal blocks 44 and associated adjustment mechanism in the direction indicated by arrow L, the vertical free-fall distance of extruded filaments between the orifice plate 15 and the top dead centerline of casting cylinder 24 may be adjusted.

Structurally, the casting cylinder 24 is preferably provided by a hollow steel shell of about four to about 5 inches diameter. A rough textured surface to the casting cylinder 24 corresponding to a coarse finishing grit is preferred for securing the hot mat-to-cylinder interface as it approaches 9 o'clock or the 90 degree position. A suitable means for such texture has been a wrap 46 of the cylinder 24 surface along its functional length with 80-grit Emory cloth, sandpaper, or vinyl stair tread material of about 80 durometer. It should be noted, however, that the invention has been successfully practiced on a bare steel roll surface, also. The cylinder 24 rotational speed is coordinated with the filament extrusion velocity from the orifice plate 15 to accumulate, develop and issue a moving bed or continuum 28 of randomly looped piles on the cylinder surface. A static body or bed of this continuum may be characterized as a mat 28. The FIG. 5 illustration represents a plan view of such a mat 28. A cross sectional cut of the mat 28 is shown by FIG. 6.

Many variables contribute to the mat 28 properties and characteristics. The polymer material selected for extrusion from a particular extrusion machine 10 will predominantly determine the extrusion temperature and velocity. The PVC polymer blend is preferably extruded over a temperature range of about 148° C. to about 163° C. To a lesser degree, the extruder equipment 10 and the size of the orifice plate apertures 16 influence the filament velocity. For example, smaller filaments would be expected to cool more quickly and, thus, the distance between the extruder and cylinder 24 may generally be reduced as the filament diameter is reduced.

Aside from the material selection, important mat control parameters are the rotational velocity of the casting cylinder 24, the filament free-fall distance 23 and the exact filament landing location within the general arc of about 60 degrees including 30 degrees before and after rotational top dead center.

As the multiple filaments engage the cylinder 24 surface, the strands collapse to lap, loop, and overlay in an entwined pile compressed only by their weight. Downward advancement of the piled continuum on the moving drum limits the pile depth and density as well as weight compression effects. When issued from the die plate 15, the material body temperature of each filament is about 148° C. to 191° C. At this temperature, each filament lap crossing fuses and bonds to form a network of inter-bonded joints which, collectively, integrate the piled continuum into a unitized mat. Lap bonds formed between filaments cooled below 149° C. are frequently weak and unreliable. Thus, free-fall height may be adjusted to control cooling of the filaments and, hence, ensure the necessary degree of filament interbonding in the resulting mat.

Rotation of the cylinder 24 carries the matted continuum 28 against the cylinder surface over an arc of from about 150° to about 210°. At or near the lower dead center position of the cylinder 24, the mat peels from the rough textured drum surface to land upon an upper horizontal run of a support web preferably provided by an endless belt 34 coursed between an idle roll 37 and a drive roll 36. The drive roll is rotatively driven as by chain 38 from a variable speed power source 39. It is noted especially that cylinder 24 in the preferred embodiment is supported in spaced relation above the belt 34 so that the mat is not compressed between the cylinder and the belt. Most preferably, cylinder 14 is spaced sufficiently above the belt 34 sufficient to provide a small gap G between the mat 28 and the belt 34 adjacent the location at which the mat 28 pays off the cylinder; about 25.4 mm, for example. Into the gap G and widthwise along the mat 28 transfer region between the lower dead center of cylinder 24 and the upper run surface of belt 34, a jet J of air may be discharged generally parallel to the traveling direction of the mat from an elongated nozzle 32 projected from air manifold 30 and supplied by a variable speed/variable volume blower 31. Preferably, the air in jet J is about ambient temperature, i.e., about 21° to 27° C.

The air jet J from nozzle 32 affects the properties of a resulting mat. A strong air flow volume and Velocity tends to accelerate expansion and cooling of the mat structure for greater loft and thickness. Long filament free fall distances also tend to form thicker, lighter mats with long radius loops. Conversely, a small filament free-fall distance tends to form a thinner, denser mat with short radius loops. Little or no air flow in gap G tends to enable generation of more dense mats with increased filament flattening adjacent the belt/mat interface as the filament cool and harden more slowly on the advancing belt.

Due to the porous, open structure of the mat 28, air flow from the nozzle 32 may penetrate the mat and follow the cylinder 24 surface up to the filament landing zone on the cylinder 24. Similarly, spillover air from the nozzle 32 may attach to the cylinder carried mat 28 and rise to the filament landing zone. To prevent the adverse consequences of air drafts originating from the nozzle 32 air supply, vertically adjustable air screens or baffles 21 and 22 may be secured to the die block 14 to screen the filament free-fall zone 23.

Length of the belt 34 between the drive and idle rolls is preferably sufficient to provide a complete cure and cooling of the filament joints upon reaching the belt end. However, a supplemental source of cooling air as at 40 may be provided for unusually dense mats or, due to floor space limitations, a belt 34 of insufficient length. Such supplemental cooling air source may be a duct supplied manifold or an array of high-capacity fans. By whatever cooling means the completed mat 28 must have cooled sufficiently by the end of belt 34 run length to leap an unsupported gap into a powered winding stand 48 for wrapping the mat continuum into a shipping or handling roll 50, and to wrap without significant interadherance of adjacent layers.

### Examples

Formulations for a polymeric winter blend (suitable for environmental temperatures ranging from −40 to 0° C.) and a summer blend (suitable for environmental temperatures ranging from 0 to 49° C.) were prepared with the components and proportions as shown in the following table.

TABLE 1

| | | | | | | | Control | Control |
|---|---|---|---|---|---|---|---|---|
| Component | A | B | C | D | E | F | 1 | 2 |
| PVC (K = 66) (phr) | 100.00 | 100.00 | 100.00 | 100.00 | 100.00 | 100.00 | 100.00 | 100.00 |
| Plasticizers (phr) | 58.00 | 58.04 | 57.99 | 58.05 | 57.99 | 58.04 | 57.99 | 58.04 |
| Rubber (phr) | 3.33 | 4.46 | 9.13 | 3.40 | 4.57 | 9.32 | 0 | 0 |
| Filler (phr) | 50.00 | 50.00 | 50.00 | 49.89 | 50.00 | 49.88 | 49.89 | 50.00 |
| Stabilizer (phr) | 4.00 | 4.02 | 3.88 | 4.08 | 3.88 | 3.96 | 3.94 | 4.02 |
| Lubricants (phr) | 2.44 | 2.46 | 2.51 | 2.49 | 2.51 | 2.56 | 2.19 | 2.46 |
| Azodicarbonamide | — | — | — | 4.54 | 4.57 | 4.66 | — | 4.46 |
| (Blowing agent) | | | | | | | | |
| (phr) | | | | | | | | |
| Colorant (phr) | 4.44 | 4.46 | 4.57 | 4.54 | 4.57 | 4.66 | 4.38 | 4.46 |
| Total | 222.22 | 223.44 | 228.08 | 226.98 | 228.08 | 233.10 | 218.38 | 223.44 |

The ingredients in table 1 were mixed and dry additives were added to the mixture at room temperature. The ingredients were mixed to a target rpm at a target temperature of about 52° C. The plasticizer was added while controlling the temperature of mixture at 52° C. The liquid components of the polymer blend were added sequentially while controlling the temperature of the mixture at 52° C. The mixture was then agitated to a secondary rpm target and the temperature of the mixture was increased to about 79° C. Additional plasticizer was added while controlling the temperature at 79° C. Liquid additives, including the plasticizer and stabilizer were sequentially added while controlling the temperature at 79° C. The final ingredients, including the filler were added while maintaining the temperature of the mixture at about 99° C. while agitating the mixture for 15 minutes. The mixture was then dropped into a cooling device for rapid stabilization at a temperature of 32° C. The mixture was then pelletized under a controlled temperature of about 99° C. The pellets obtained from the foregoing mixing process are later mixed in the loading system of the extruder with the blowing agent and colorant.

The pelletized material coming from the previously mixed materials of table 1 were extruded in combination with the ingredients from table 2 in an apparatus of FIG. 1 at a temperature of about 179° C. The blowing agent of Table 2 may be added initially with the ingredients from Table 1, or may be added later in the extruder before the mixture is extruded through the die.

During the extrusion process, the casting cylinder was rotated at an approximate tangential speed of 76 cm/min. The distance between the orifice plate and the top dead centerline of the casting cylinder was 17.8 cm allowing the material to set into final strand thickness of 1.115 mm. With this the bonding of fibers allow the product to reach the properties expected for the application, preserving a light material configuration.

The typical die used to extrude the polymer blend was a 188 cm long die with 1200 die holes of 0.79 mm in diameter, allowing the strand pattern and thickness with minimum open spaces or areas which no material available. This is important as the material will cover 90%+ of the surface giving its maximum protection and usability in a different application.

Once the material is on the belt cooling down, an air flow may be applied before spooling the mat material into rolls to stop deformation of the mat under its own weight. At the same time, the mat material may be sized to different sizes by using motorized cutters in one or more borders.

Occasionally, the extrusion will require another forced air flow close to the roll in order to keep the thickness of the material in line with the specifications as explained in FIG. 1, but this is optional and related to environmental variables at the extruder and minor variations resulting from the incoming material.

Since it is difficult to determine some of the physical properties of the extruded polymer strands once the mat is made, the following tables and graphs illustrate how the amount of rubber in the polymer blend with or without a blowing agent has on the properties of a sheet of material made from the polymer blend. The formulations tested are included in Table 1 and the properties of test plaques made from the extruded sheets are shown in Tables 2 and 3.

Tables 2 and 3 provide additional examples of PVC formulations containing rubber with and without a blowing agent that were extruded and tested for 100% modulus, tensile strength, and elongation at ambient temperatures and at freezing temperatures for 24 hours. The controls samples 1 and 2 provide baseline information for the PVC formulations devoid of rubber with and without blowing agents.

TABLE 2
Tested At 20° C.

| Physical | | | | | | | | Control | Control |
|---|---|---|---|---|---|---|---|---|---|
| Properties | ASTM | A | B | C | D | E | F | 1 | 2 |
| Specific | D-792 | 1.38 | 1.38 | 1.37 | 1.37 | 1.28 | 1.31 | 1.39 | 1.38 |
| Gravity | | | | | | | | | |
| Hardness (A | D-2240 | 88/84 | 89/84 | 88/84 | 89/84 | 86/81 | 86/81 | 88/82 | 88/84 |
| Scale, | | | | | | | | | |
| instant/15 sec) | | | | | | | | | |
| Tensile | D-412 | 1610 | 1631 | 1421 | 1561 | 1417 | 1090 | 1970 | 1302 |
| Strength (psi) | | | | | | | | | |
| 100% | D-412 | 1197 | 1224 | 1194 | 1197 | 1175 | 975 | 1278 | 1017 |
| Modulus | | | | | | | | | |
| (psi) | | | | | | | | | |
| Elongation | D-412 | 213 | 220 | 183 | 194 | 166 | 140 | 271 | 184 |
| (%) | | | | | | | | | |
| Equilibrium | | 577 | 582 | 550 | 555 | 536 | 515 | 619 | 609 |
| Torque 60 | | | | | | | | | |
| RPM, 160C | | | | | | | | | |
| (mg) | | | | | | | | | |

TABLE 3
Tested At −12° C. for 24 hours

| Physical | | | | | | | | Control | Control |
|---|---|---|---|---|---|---|---|---|---|
| Properties | ASTM | A | B | C | D | E | F | 1 | 2 |
| Hardness (A | D-2240 | 88/84 | 88/84 | 88/84 | 85/80 | 85/81 | 82/77 | 89/84 | 82/77 |
| Scale, | | | | | | | | | |
| instant/15 sec) | | | | | | | | | |
| Tensile | D-412 | 1625 | 1783 | 1553 | 1414 | 1294 | 1090 | 1946 | 1337 |
| Strength (psi) | | | | | | | | | |
| 100% | D-412 | 1258 | 1242 | 1224 | 1153 | 1173 | 960 | 1250 | 1023 |
| Modulus | | | | | | | | | |
| (psi) | | | | | | | | | |
| Elongation | D-412 | 210 | 244 | 199 | 169 | 138 | 141 | 272 | 196 |
| (%) | | | | | | | | | |

As shown in the foregoing tables, the presence of a blowing agent reduces the tensile strength and modulus as the amount of rubber in the polymer blend is increased. Formulations E, F, G and Control 2 were made with a blowing agent and Formulations A, B, C, and Control 1 were made without a blowing agent.

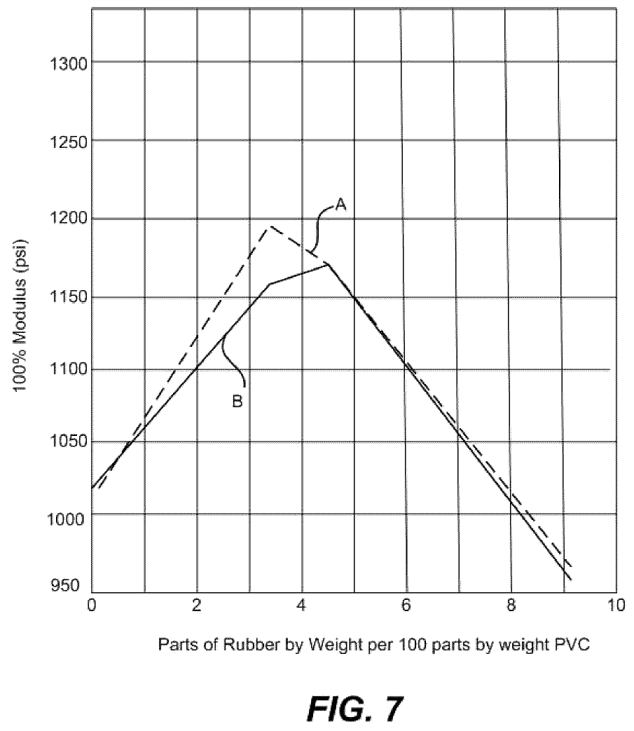

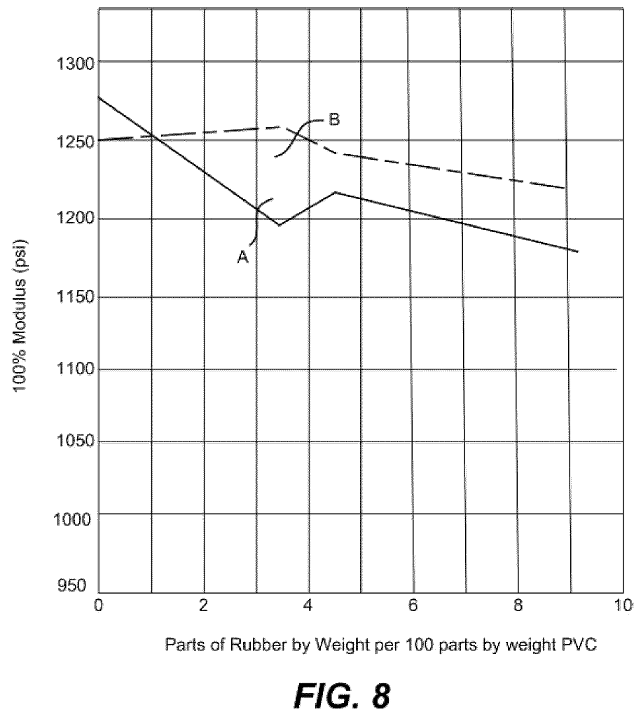

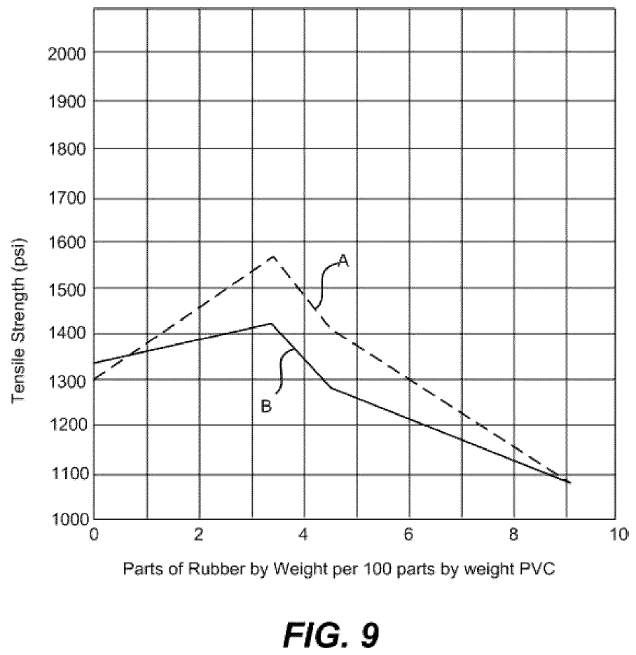

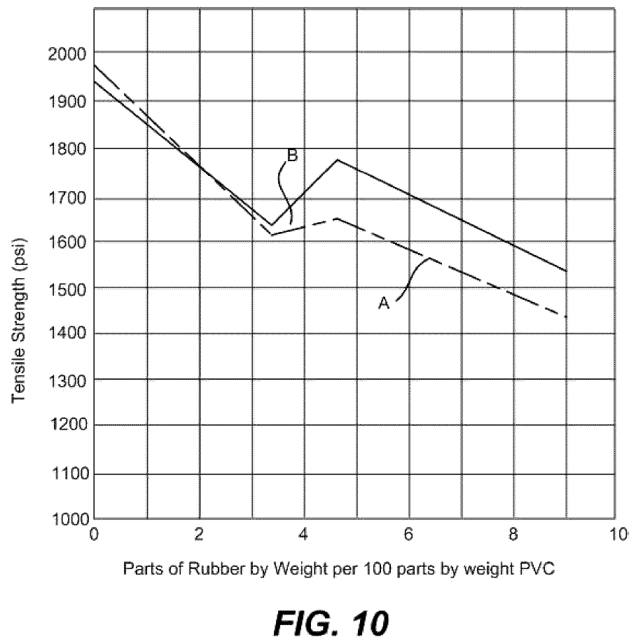

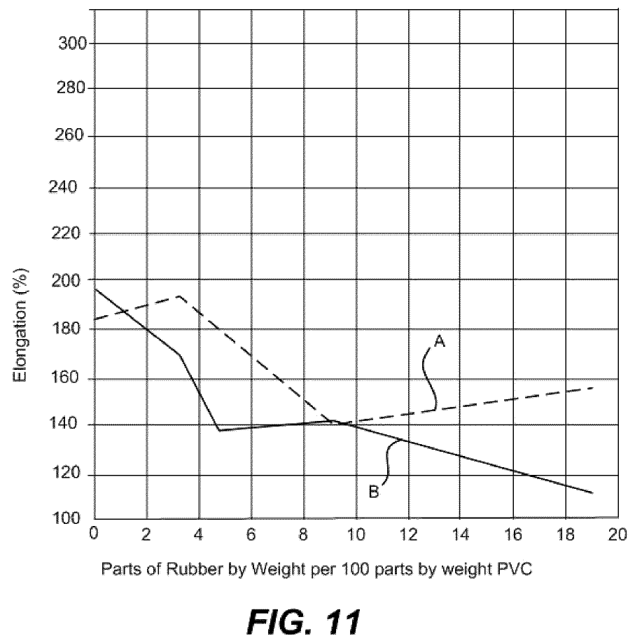

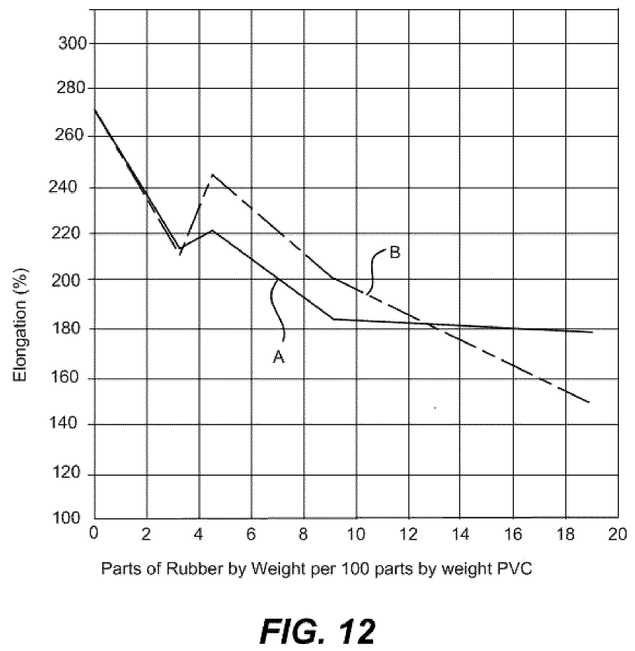

With reference to FIGS. 7-12, the foregoing data illustrates the effects of the addition of rubber on the tensile strength, modulus, and elongation under ambient conditions at 20° C. (Curve A) with and without a blowing agent and after 24 hours at a temperature of −12° C. (Curve B) with and without a blowing agent. In FIG. 7, the optimum amount of rubber that improves the 100% Modulus of the extruded product when used with a blowing agent ranges from about 2.8 parts per weight to about 4.0 parts per weight per 100 parts per weight PVC (Curves A and B) at ambient and below freezing temperatures. As shown in FIG. 8, in the absence of a blowing agent (Curve B), the same amount of rubber improves the 100% Modulus at freezing temperatures. Likewise in FIG. 9, the optimum amount of rubber that improves the tensile strength of the extruded product when used with a blowing agent ranges from about 2.8 parts per weight to about 4.0 parts per weight per 100 parts per weight PVC (Curves A and B) at ambient and below freezing temperatures. As expected in FIG. 10, in the absence of a blowing agent (Curves A and B), the addition of rubber reduces the tensile strength in the absence of the blowing agent. FIG. 11 shows, that when a blowing agent is present (Curve A), the use of 1.5 to about 3.5 parts by weight rubber per 100 parts by weight PVC improves the elongation at 20° C. Otherwise, FIGS. 11 and 12 show that rubber generally lowers the elongation over formulations devoid of rubber at temperatures above and below freezing in the presence or absence of a blowing agent.

Based on the results, the use of rubber in the range of 2.8 to 4.0 parts by weight of rubber per 100 parts by weight PVC is critical to improving the 100% modulus and tensile strength of strands made from the PVC blend in the presence a blowing agent in temperatures above and below freezing and improves the elongation of the PVC blend above freezing in the presence of a blowing agent. In the absence of a blowing agent, the claimed amount of rubber is useful for improving the modulus of strands made from PVC for use in below freezing temperatures. Above about 5 parts of rubber by weight per 100 parts by weight of PVC, processing of the blend becomes more difficult and expensive and is not likely to significantly improve the properties of the extruded polymer strands. Accordingly, using more than 5 part by weight per 100 parts by weight PVC is to be avoided.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A non-woven polymeric mat for protecting pipelines, the mat comprising a plurality of extruded, strands derived from a polymer blend of a pelletized polyvinyl chloride (PVC) resin having a k-value ranging from 60 to 70 and an olefin-based thermoplastic elastomer (TPE), wherein the amount of TPE in the polymer blend ranges from about 2.8 parts by weight to about 4 parts by weight per 100 parts by weight of PVC resin in the polymer blend and is sufficient to improve the modulus and tensile strength of the mat, and further wherein the polymer blend is devoid of a nucleating agent and devoid of a cross-linking agent, and wherein the extruded strands have a specific gravity ranging from about 1.25 to about 1.4.

2. The non-woven polymeric mat of claim 1, wherein the polymer blend further comprises a plasticizer.

3. The non-woven polymeric mat of claim 2, wherein the plasticizer is selected from the group consisting of dioctyl phthalate (DOP), dioctyl terephthalate (DOTP), dioctyl adipate (DOA), tri-2-ethylhexyl trimellitate (TOTM), epoxide soybean oil (ESO), and mixtures thereof.

4. The non-woven polymeric mat of claim 2, wherein the amount of plasticizer in the polymer blend ranges from about 50 to about 60 parts by weight per 100 parts by weight of the polymer blend.

5. The non-woven polymeric mat of claim 1, wherein the extruded foamed strands are derived from a polymer blend further comprising a blowing agent.

6. The non-woven polymeric mat of claim 5, wherein the blowing agent is present in the polymer blend in an amount ranging from about 4.0 to about 5.0 parts by weight per 100 parts by weight of the PVC resin in the polymer blend.

7. The non-woven polymeric mat of claim 5, wherein the amount of TPE in the polymer blend ranges from 3.0 to about 3.5 parts by weight TPE per 100 parts by weight PVC resin in the polymer blend.

8. A method for making a polymeric non-woven mat, comprising preparing a polymer blend comprising pelletized polyvinyl chloride (PVC) resin having a k-value ranging from 60 to 70, a thermoplastic olefin elastomer (TPE) in an amount ranging from about 2.8 to about 4.0 parts by weight per 100 parts by weight of PVC resin in the polymer blend, and a plasticizer, wherein the polymer blend is devoid of a cross-linking agent, further comprising the step of extruding strands derived from the polymer blend through a die onto a rotating casting cylinder to produce the polymeric non-woven mat derived from extruded polymer blend wherein the strands of the polymeric non-woven mat have a specific gravity ranging from about 1.25 to about 1.4.

9. The method of claim 8, wherein the plasticizer is selected from the group consisting of dioctyl phthalate (DOP), dioctyl terephthalate (DOTP), dioctyl adipate (DOA), tri-2-ethylhexyl trimellitate (TOTM), epoxide soybean oil (ESO), and mixtures thereof.

10. The method of claim 9, wherein the amount of plasticizer in the polymer blend ranges from about 50 to about 60 parts by weight per 100 parts by weight of the PVC resin in the polymer blend.

11. The method of claim 9, wherein the polymer blend comprises a blowing agent selected from the group consisting of azodicarbonamide, azobisisobutyronitrile, benzenesulphonyl hydrazide, 4,4-oxybenzenesulphonyl semicarbazide, 4,4-oxybis(benzenesulphonyl hydrazide), diphenyl sulphone-3,3-disulphonyl hydrazide, p-toluenesulphonyl semicarbazide, sodium bicarbonate, ammonium carbonate, ammonium bicarbonate, potassium bicarbonate, diazoaminobenzene, diazoaminotoluene, hydrazodicarbonamide, diazoisobutyronitrile, barium azodicarboxylate and 5-hydroxytetrazole.

12. The method of claim 9, wherein the blowing agent is present in the polymer blend in an amount ranging from about 4.0 to about 5.0 parts by weight per 100 parts by weight of the PVC resin in the polymer blend.

13. The method of claim 9, wherein the die has orifice diameters ranging from about 0.2 mm to about 0.8 mm.

14. The method of claim 9, further comprising discharging a jet of air from an elongated nozzle into a gap widthwise between the strands and the rotating cylinder substantially parallel to a traveling direction of the non-woven mat to increase or decrease a density of the non-woven mat.

15. The method of claim 8, wherein the extrusion takes place at temperatures ranging from about 148° C. to about 163° C.
